(19) United States
(12) Patent Application Publication
(10) Pub. No.: US 2023/0004720 A1
(43) Pub. Date: Jan. 5, 2023

(54) Logos Communication Platform

(71) Applicant: Walter Pelton, San Jose, CA (US)

(72) Inventor: Walter Pelton, San Jose, CA (US)

(21) Appl. No.: 17/478,848

(22) Filed: Sep. 17, 2021

Related U.S. Application Data
(60) Provisional application No. 63/218,264, filed on Jul. 2, 2021.

(51) Int. Cl. G06F 40/30; G06F 40/58; G06F 16/33

(52) U.S. Cl. CPC G06F 40/30; G06F 40/58; G06F 16/3344

(57) ABSTRACT

This disclosure presents a comprehensive system that allows the storage of Meaning in a manner able to be accessed in any supported language, be processed under a rigorous mathematical methodology, and combine the information content of multiple files. Able to search, compare, paraphrase, and excerpt unambiguously by computer programs. Identify and present conflicts between files that an editor may resolve. The system incorporates corruption-resistant technology to prevent malicious damage, and a shell treats language-based documents as assets or NFTs. An integral coin-based asset/currency is designed to be sold, traded, earned, and bartered. A serial number allows that whole coins, stolen or permanently lost, be tracked to a wallet or canceled, reducing theft-reward.

Human communication has progressed from primitive sounds through extensive vocabularies, highly structured systems, and creative expression methods. These often include multi-level terms that provide one general meaning to most listeners but have subtle implications for certain people.

Archeological and DNA mutation evidence currently provides a timeline indicating that the beginning of modern humans was about 200,000 years ago, and they slowly began communicating. The oldest preserved art presently identified is on cave walls. It appears to date back 85,000 years and consists of handprints (dipped in red ochre clay). Let us call that the beginning of human records. They were symbols of the persons who made them, the earliest signatures. Slightly newer cave art comprised drawings of animals. The illustrations mainly were of game prized for food and hunting, such as caribou, giraffes, and wildebeests. Lions, tigers, and hyenas may have received verbal names, but they did not become considered objects to pursue (or draw). It is fair to assume that the images also had associated sounds, and there is reason to believe that there was a spoken language perhaps 100,000 years ago.

There are burial places with tools, beads, and ornaments for Homo sapiens and others for Neanderthals, from around 50,000 years ago. There are signs that people had belief systems and were involved in making plans to defend against predatory animals and each other. Not many records have survived and become translated from the next 40,000 years. By 10,000 years ago, it is clear that ledgers and art were quite advanced, supporting rulers and trade.

The contexts of later writings were those of the addressee (Caesar's letters to the Citizens of Rome), whereas Plato and Hippocrates addressed their pupils and all humanity. Centuries later and in far distant countries, people require maps and a history course to comprehend them with a clear perspective. We must know the context and the words to understand the documents. The Hebrew histories and the Vedic texts seem to indicate that some very advanced languages existed.

The present state of communication is that each profession and company is building divergent vocabularies. Therefore a pharmaceutical chemist and a building architect talking about the weather may be mutually exasperated. It is time to let computers systematically eradicate the difficulty. Although each language has conventions about inter-language translation, the process is primarily an art. It depends on a translator to create a general flow that clarifies the subject between two languages. There is a need to have a uniform system that can extract meaning, make it available in any language, and become rephrased or paraphrased. Even if the chemist is an Iranian tourist and the architect is French.

Recently there has been the advent of digital hierarchy. Characters, numerals, and punctuations become assigned numeric representations. Images become frames containing pixels and other constructs under various rules. Software (fully numerical) directs all of these, and they finally become structured streams of numbers. The process of approximately representing things by numbers is called digitization.

The mythical Tower of Babel described this long ago, but the solution was not apparent within the practical limits of that time. It has become possible to consider each definition in each language a metaphor and assign it a single digital value. It is also possible to equate many sets of metaphors (not all) to discrete thoughts (called sentences in the English language, but still to be considered metaphors) and describe each in every language. By adding context, each such sentence can have meaning. These possibilities imply that the Tower of Babel may become disassembled, and its bricks may become the pavement of a communication superhighway into the future.

Certain developments, such as tools, weapons, fire, words, ledgers, governments, ships, laws, money, war, politics, copper, bronze, wheels, iron, automobiles, electricity, and artificial lights, have been enduring in the record of civilization. Once each became identified and assimilated, it persisted without question into all successive dominant societies. We must add new members to the growing list: digitization, computers, encryption, distributed ledgers, cyber coins, and Non-Fungible Tokens.

### A BRIEF DESCRIPTION OF THE DRAWINGS

FIG. 1 shows the process of converting an author's input into a universal language and summary.

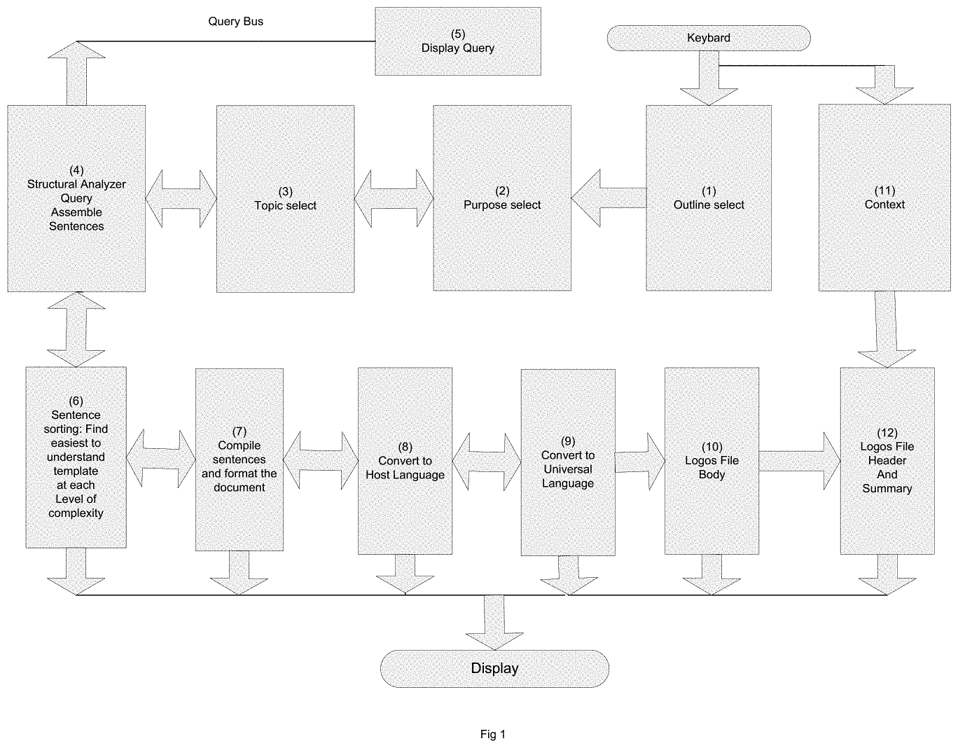

FIG. 2 shows the process of combining a digital number (DigiMet) with the context and language to obtain synonyms.

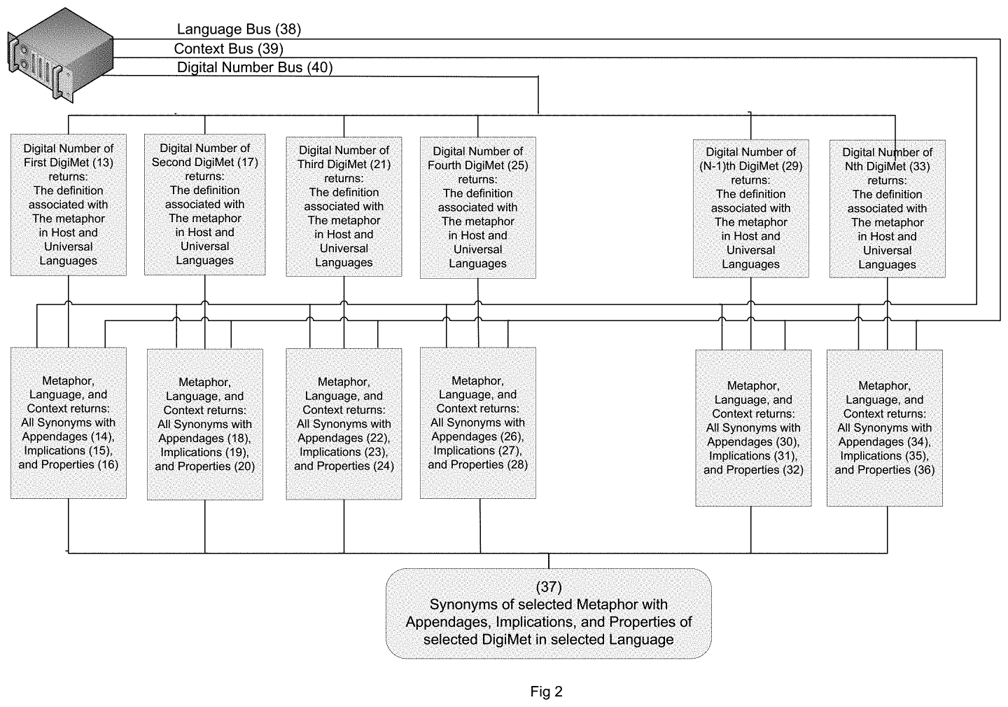

FIG. 3 shows the structural layout of data in a DigiMet and in a synonym.

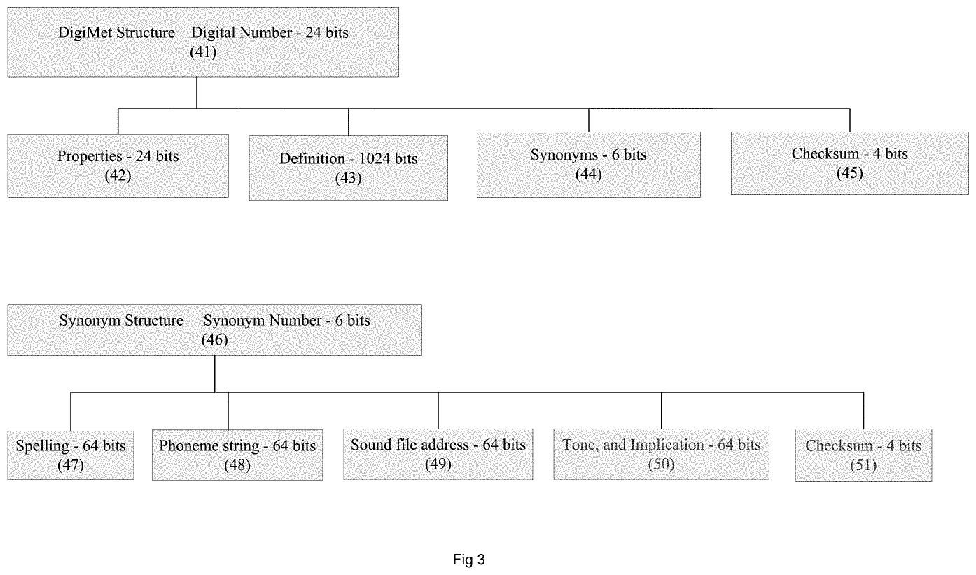

FIG. 4 shows the process of support of an author in the Frame and Storyline process and the structural layout of data in the Frame, the sentence type, and the sentence structure.

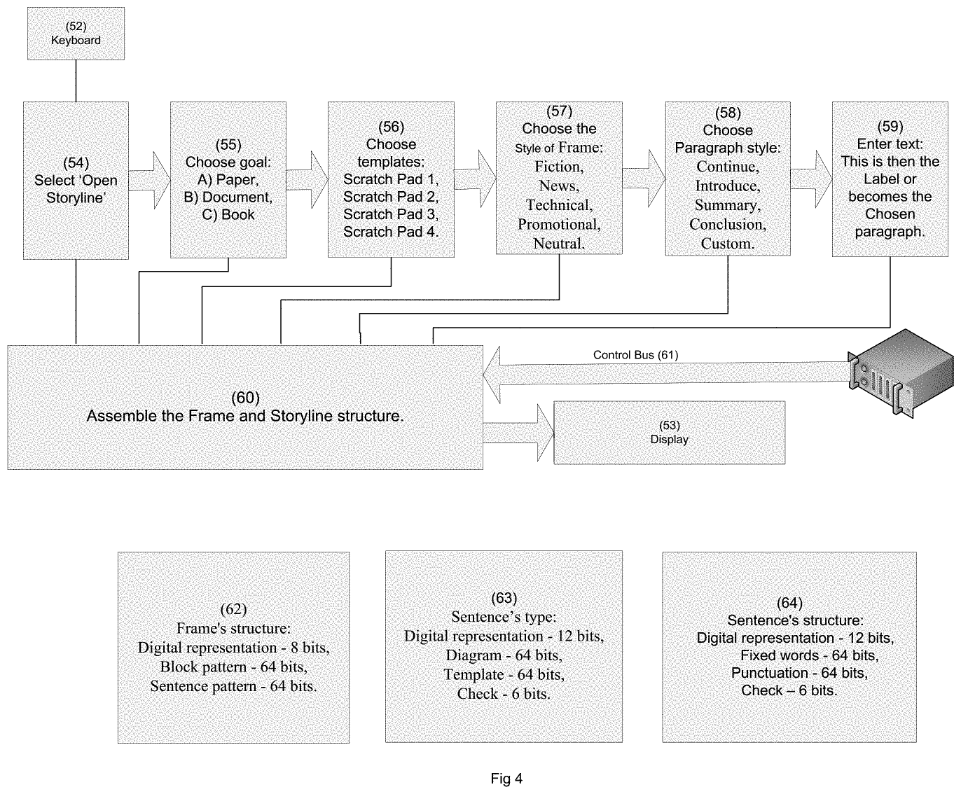

FIG. 5 shows the process of combining the Logos information with the Logos file header and Logos file body through the structural analyzer and reference to the metaphory to display the output.

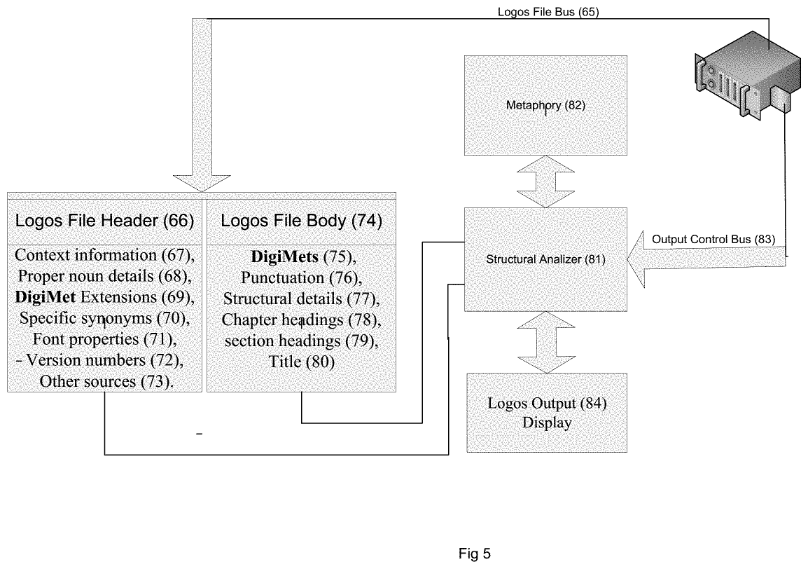

FIG. 6 shows the process of converting a communication file plus queries and answers into an output file in a chosen language, part of speech, gender, and other parameters into a platform output file.

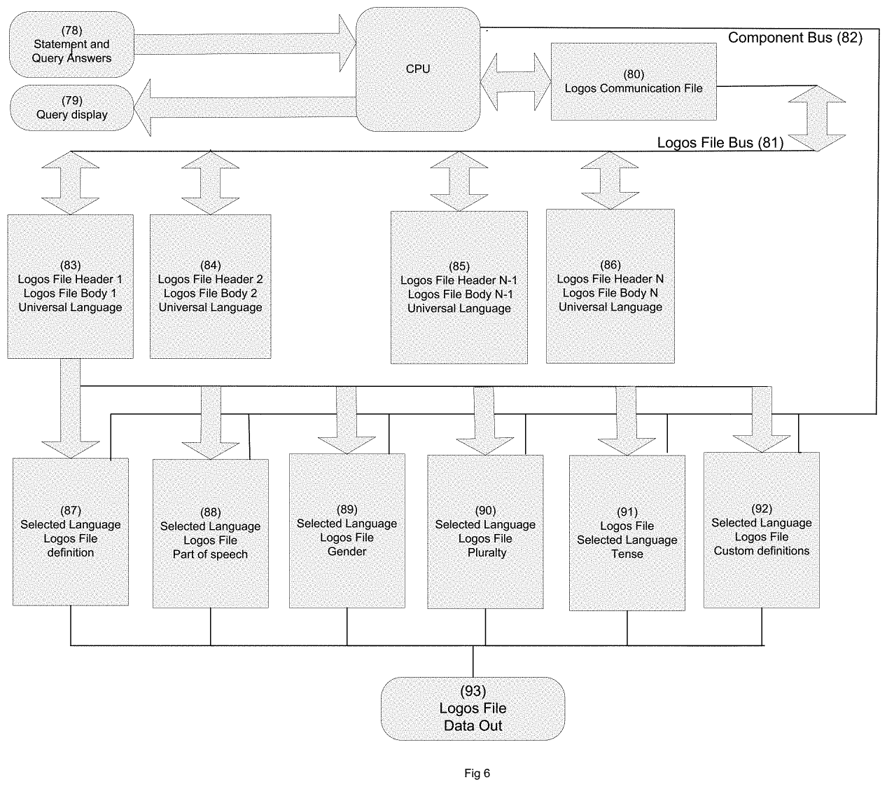

FIG. 7 shows the process of converting LogosCoins to become owned (with serialization) and enter into circulation and the process of generating nonfungible LogosContract tokens that can become validated.

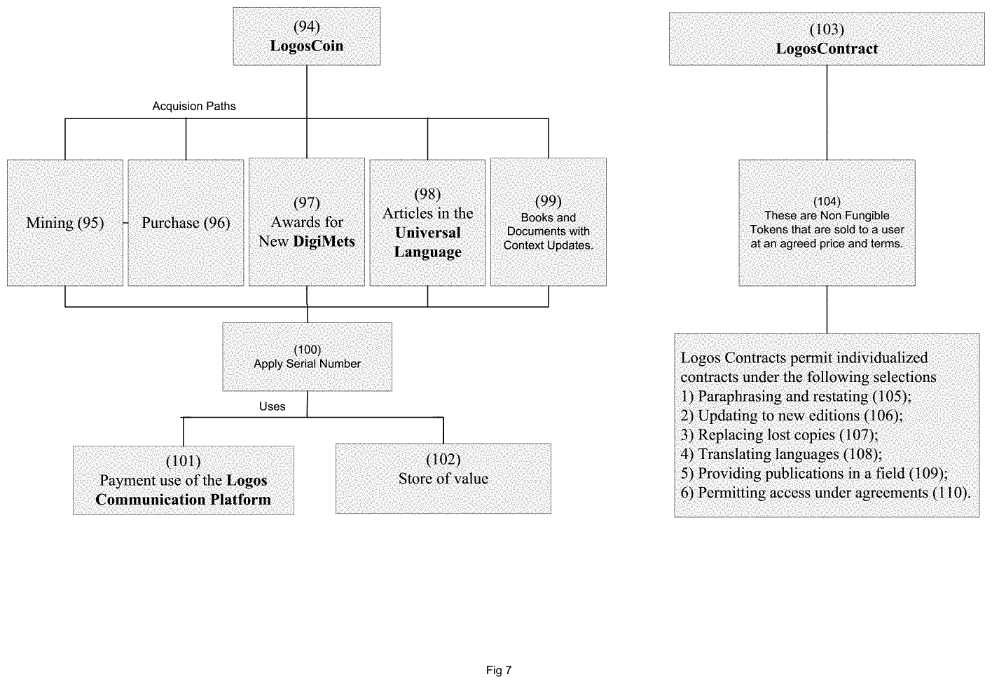

### DEFINITIONS OF SOME TERMS

1. Language: a set of metaphors, constructs, punctuation, and grammar rules that express thoughts and contexts. No metaphor can express a real-world absolute; therefore, the interpretation is subjective. Current Languages define each word by other words and thus fail to be rigorous.
2. Knowledge: is the personal understanding possessed by an individual; it is primarily analog and consists of experiences, opinions, emotions, metaphors, visual recall, olfactory recall, numbers, ideas, beliefs, priorities, attitudes, and context. (No set of metaphors can express Knowledge precisely.)
3. Host Language: a Language that becomes chosen as the standard Language. (A standard Language is necessary to allow accuracy in repeated translations by avoiding the accumulation of errors over multiple quasi-translations.)
4. Defining words: A subset of the Host Language in which each word/symbol becomes defined uniquely; each becomes identified by illustrations and descriptions, videos, sounds, odors, and words. Each of the Defining words may become learned from its definition by a person without knowledge of the Host Language. Each word is a context-free metaphor. They become used to define all word/phrase metaphors for all Languages. (Limiting the size of this subset limits the fineness of resolution of the definitions; each Defining word may become displayed as;
   1) The illustrations, descriptions, videos, sounds, odors, and words defining that Defining word,
   2) A set of other words (a symbol - what would be a definition if it were not a Defining word),
   3) A unique alpha-numeric word symbol; to wit: cow1, cow2, cow3 . . . ,
   4) A set of synonyms in a specified Language, or
5) A digital identification number.
5. Formality Level: is a designation assigned to each synonym to indicate its usage, priority, and range of acceptability; it includes grade level, occupational jargon, era, geological period, religion, date of first use, and other cases of distinctions within the vocabulary.
6. DigiMet: A context-free metaphor with a numerical identification, a unique definition (in Defining words or by illustrations and descriptions, videos, sounds, odors, and symbols), and identifies its tense, part of speech, gender, plurality, parameters, and an appendage for each synonym (each synonym includes its pronunciation, symbol, Formality Level, and implication); each Language must become provided with an appendage that provides the synonyms, their symbols, Formality Levels, and pronunciations for the Language. Because of digitization, it will carry a finite uncertainty when combined in a metaphor.
7. Logos: is an unambiguous metaphor; composed of DigiMets plus punctuation, constructs, and grammar rules; it has no inherent context.
8. Meaning: is a metaphor plus a corresponding context. It may be either analog or digital.
9. Digital meaning: is a metaphor composed of DigiMets, structured according to grammar rules and a corresponding context comprising DigiMets; it can provide detailed information to a controllable accuracy and is unambiguous. It has a finite uncertainty due to the digitization of DigiMets.
10. Communication: is the transfer of Meaning from a sender to a receiver(s).
11. Logos Communication Platform: A channel that receives a message from a source and extracts the Digital meaning, providing prompts and queries to the source to complete each subject and verify that the Communication is complete and unambiguous Logos plus context, which it stores or passes to receivers that restore it into symbols, punctuation, grammar, and the context in any supported Language(s) providing a means for the receiver(s) to rephrase the wording and review each word/phrase metaphor's synonyms to understand the message.
12. Logos File: A component of the Logos Communication Platform in which unambiguous DigiMets replace all ambiguous word/phrase-metaphors; grammar rules become used to form an unambiguous metaphor (composed of multiple metaphors) plus a context that becomes separately preserved; it cannot represent absolute real-world truth; it is also subject to the statements that were its inputs (which may be opinions, facts, or lies); no number of metaphors can precisely express Knowledge; this limitation can become lessened by using more and longer sentences, adding more DigiMet definitions, plus context and can become very (but not infinitely) close to the intended Meaning.
13. Logos File Header: A structural component of a Logos File containing the default context in which the metaphor will become presented, plus support information that the software proactively obtains by queries when a noun, pronoun, or nominative phrase becomes introduced; it can become pre-populated, leaving the software to identify each item upon instantiation; whenever the resources used have version numbers, they become stored in the Logos File Header, all information is available when researching the Meaning.
14. Logos File Body: A structural component of a Logos File containing an unambiguous context-free Logos metaphor composed of DigiMets, capitalizations, punctuations, grammar, paragraphs, and chapters according to the elements required to structure and express it.
15. Logos of Man: An archive of Logos Files, excerpts from a file may be out of context because each file has its independent Logos File Header, the files may become updated to a single context, which will change some display details, the Logos File Bodies will retain their metaphors; the Logos Files may then become combined without a loss of context, search of a Logos File(s) presents results in the form of a new Logos File.
16. Blockchain: is an open-source distributed-ledger system (introduced under Satoshi Nakamoto) that protects the integrity of information against corruption by requiring multiple participants to verify successive ledgers independently; Logos Files, Logos File Bodies, and Logos File Headers may become formatted as ledgers and, in this document, it includes any similarly corruption-resistant variant.
17. Universal Language: is a list of each digitized representation number (DigiMet) of every definition in all supported Languages; it includes rules of grammar, punctuation, structure and is unambiguous; its definitions are in Defining words, can be translated into another Language to become better understood but these translated definitions may not become substituted into DigiMets because that would introduce differences in Digital meaning and lose its mathematical precision.
18. Logos Repository: a validated subset of the Logos of Man, it is Blockchain-protected information storage; each Logos File is self-consistent and has an independent Logos File Header; it is the second-highest level in the Logos hierarchy.
19. Integrated Logos Repository: is a Blockchain-protected system of information storage with one Logos File Header; it is the highest level in the Logos hierarchy, the contents are a subset of the Logos Repository, the information content becomes seamlessly integrated; it can return a book-like output for a search based on a set of selections with chronological order being an option, it becomes able to grow to be a resource that may be generally relied on for definitive information.
20. Metaphory: is an enumerated list of all DigiMets; it is a moving target (as is a dictionary) and applies to the work in progress; it can support translation forward or backward, and other mathematical functions; a call to it becomes made by entering the digital number of a DigiMet. It returns the definition along with associated appendages and properties.
21. Symbolory: is a reordered form of the Metaphory. A call to the Symbolory (within a Language) becomes made by entering a word/phrase symbol, which will return the synonym word-symbols and digital numbers of all DigiMets represented by the word/phrase symbol (similar to a dictionary). It also filters by context, giving the appropriate words/symbols and their pronunciations. The Symbolory may be pre-computed (to provide a significant decrease in the use of computational resources.) In this document, each reference to Metaphory implies the Symbolory.
22. Definory: This is a form of the Metaphory optimized to search the DigiMet definitions. A call to the Definory becomes made by entering the digital number of the desired DigiMet. It returns the associated DigiMet numbers of synonyms. The Definory may be pre-computed (to provide a significant decrease in the use of computational resources.) In this document, each reference to Metaphory implies the Definory.
23. Language package: This is a database that associates each of the DigiMets in the Metaphory with an appendage that includes the synonyms and their implications of each in the Language; these include phoneme and sound files, grammar rules, grouping rules, plurality, and other details of the Language; it is Blockchain protected as changes to it may have catastrophic consequences.
24. Structural Analyzer: This interactive software system can convert unambiguous Logos into any supported Language's proper grammar and order by accessing the Language Package's rules and conventions, including means to resolve exceptional cases, determines whether the current paragraph is of the required format, correct form, and consistent with all details (actual name, date of birth, or other); supports the translation of a Logos File into a Language; able to rephrase and provide synonyms. When there is a lack of valid data, it will generate a query for an editor to either provide the missing data or make it undefined.
25. MetaMath (Metaphor-Based Algebra): This is an algebra that uses the Universal Language, DigiMets, and structure rules (metaphor-order, punctuation, sentence, grammar, line-feed, and paragraph structure) to calculate equivalencies to combine and simplify metaphors; each DigiMet is a unique dimension; it can integrate simple sentences into complex sentence structures or split complex sentences into multiple simple sentences; it cannot form an absolute external Digitized meaning by using DigiMets (which are metaphors); it can grow forever, as can any mathematics; it cannot compensate for incorrect input; to be rigorous, it must only operate in the Universal Language and the Host Language for rephrasing; otherwise, translations cannot be reversible.
26. Master Repository: is a structure that includes the Metaphory and any Language package(s); it integrates MetaMath and the Structural Analyzer software to interface to provide a connection of the Host Language to the current Language; new definitions in a subset of the Host Language may be added to each Language and incorporated in Logos Header Files; each becomes unique to a DigiMet; each definition is in ‘sixth-grade’ (8,000 DigiMets—not word/phrase-metaphors) vocabulary and resides in it; there is a trade-off between the precision of the definitions possible and the size of this subset.
27. Frame and Storyline: This system allows a skeleton framework to be structured and then carries the burden of detailing, freeing the author to concentrate on the information content; the Metaphory and Structural Analyzer software thus become supported, the resulting Logos File is unambiguous and can become directly displayed in any supported Language, it incorporates templates rather than sentence diagrams, and these use MetaMath differently to form equivalent standard sentences more directly but with less freedom.
28. Phonary: This is an ordered listing of word/phrase metaphors from the Metaphory through a Language package, with pronunciations beginning with a specific phoneme sequence.
29. Rhymary: This is an ordered listing of word/phrase metaphors from the Metaphory through a Language package, with pronunciations that end with a specific phoneme sequence.
30. Punary: This is an ordered listing of word/phrase metaphors from the Metaphory through the Language package: homonyms of a target word/phrase metaphor.
31. Digital meaning-Thesaurus: Digital meaning-Thesaurus: This is a software routine that extracts word/phrase-metaphors that include exact or similar definitions as a search symbol; it will return all spellings and phrases that are synonyms, plus the synonyms of each of their spellings; it is only necessary to enter a word symbol to display the return set This software is Language independent and can become set to the Language package of choice.

### Description of the Logos Communication Platform

### Introduction to the Logos Communication Platform;

The Logos Communication Platform is a systematic structure for extracting and recording the meaning of a statement in one supported Language and storing it as a meaning that can become expressed in any supported Language. It has become understood that replacing words in a Language provides a pattern that allows sentient individuals to fathom a meaning. It does not grammatically state in that Language. Taking the example of English, the words must form sentences before there is a thought. Many words have multiple meanings, and there must be paragraphs with topics before there are clear concepts. The order of the presentation alters the tone and intent. Many communications are only skeletons of complete statements. This platform provides specific structures.

If we have a complete Language and know each word's definition, that does not mean that we can communicate. It is no more helpful than having an alphabet. The meaning becomes evident by how we apply words. We have customary phrases and structures that we use, and every Language depends on similar concepts.

The purpose of the Logos Communication Platform is to query and record the individual elements of meaning until it becomes a set of unambiguous sentences, paragraphs, and punctuation that comprise a complete statement. It remains for the author (editor) to settle that the components' choices represent the intended thought. Once there is an exact statement, the software can transfer it into a Universal Language and store it to become expressed in any form and any Language. The Universal Language must contain enough detail to become translated into all Languages. Some words must reflect whether the speaker is male, older, or other categories.

Because the Universal Language is complete and therefore lengthy and challenging to read, the platform will generally become instructed to use sentences at a moderate level of understandability. The Logos Communication Platform will also select terms that fall into common usage with rotation of synonyms. In any spoken Language, many words have several meanings and must therefore become available to be clarified by their synonyms and in different sentence structures. The Logos Communication Platform may insert sentences to provide synonyms or make the text terse according to the reader's choice.

The system of outputting a meaning uses the fact that each word's definition is a dimension (although this is not a hard fact). A group of words in the Universal Language placed by the Logos Communication Platform with punctuation becomes directly translated to a thought. Therefore it has a template available that can become repopulated with various synonyms in each supported Language, and many templates have equivalent templates such as two simple sentences may equal a complex sentence.

In this manner, a complex idea can become stored in the Universal Language and become presented in any supported Language. This reasoning may become expanded in two axes. First, a several sentence paragraph can include punctuation that requires it to become fully processed before sentences are assigned. Some Languages must observe such markers to be easily understood. The second is that these markers allow a further degree of freedom when rephrasing so that a reader will become provided with every opportunity to understand the information. The point is that the context must be present to provide meaning. A digital meaning is not an analog meaning, but it can come very close with these factors accounted.

Introduction to the Logos Digital meaning;

Digital meaning derives from a combination DigiMets and a corresponding context to provide an unambiguous metaphor plus a context. The metaphor becomes a defined structure (Logos Body) to convey a ‘pixilated’ Meaning. The limitations are then in the number of unique meanings (number of DigiMets plus context). A Digital meaning entails a degree of error similar to a digitized image plus its title. If there are too few colors and pixels, the viewer is left to complete the view based on personal experiences and imagination. The metaphor must have a sufficient number of different DigiMets and a sufficiently detailed metaphor to provide a clear Digital meaning when viewed in its context. The DigiMets are analogous to colors, and the explicit statement is similar to the pixels; the context becomes the setting. The word ‘Meaning’ includes ‘Digital meaning’ and will become used unless ‘Digital meaning’ is necessary to clarify or avoid ambiguity.

A Meaning is not a certain truth. For instance, a lengthy contract that has become carefully negotiated may still become disputed, and a judge must be the final factor in determining its intent. After assessing the significance of every word, the contract is then being viewed similarly to a Digital meaning.

A Digital meaning can convey an unambiguous analog Meaning (limited by digitization error) but not absolute truth. However, if an authorized entity verifies it, it may then be relied upon as valid by those who accept that authority.

An image of a large green field may seem pleasant, but it will gain in context and Meaning if it is titled ‘Kansas In May.’

A detailed text that describes the principles of balancing, speed, momentum, center of mass, and steering may seem vaguely sensible at first reading. However, when it includes ‘riding a motorcycle,’ it acquires a relevant Meaning.

It is essential to establish a perspective about the digitization of Knowledge. There is no realizable way to precisely capture all that anyone knows using current methods. Suppose an expert designer wishes to convey his Knowledge. The discourse will be limited to words, images, stories, formulas, analogies, references, parables, and other concepts. However, it cannot provide his Knowledge, a personal perspective unique to the designer. An individual may need to express the Knowledge in many different ways before the information becomes unambiguous, even to an attentive audience; the process depends on the individual and the audience sharing Language, experiences, and images (collectively context) to make the conveyance effective. Therefore, there needs to be a system to structure and standardize the process. The Logos Communication Platform provides the required structure.

The current methods of collecting Knowledge are pretty scattered. Suppose that a well-developed technology is to become duplicated in another place. The process requires relocating people, teleconferences, and training. If it is to become repeated, a team must become formed to carry out the steps. Clothing manufacture occupied much of the total labor of people in the 1700s. Looms and sewing machines have caused a revolution in the industry, which now uses a small part of the entire working hours in the 2000s. There will be a similar revolution in Communication. The course will be inevitable as sentence forms and structures move from art to become a process. It currently requires a team of specialists to bring Knowledge into the public domain. The person who develops a technology may not possess the requisite skills to forward it to the world. Computers must become enabled with systems to guide and empower Communication.

It helps to provide an unambiguous metaphor and a context that may consist of times, localities, sounds, images, scents, electric shocks, and other supplemental environmental support to create a Logos File. However, the metaphor depends on the interaction of MetaMath with the author. Furthermore, the richness of the context may become limited by the technology available.

As civilization expands, people will become more interconnected. The result of this will be a greater need to store and share Logos. That will require people to define and develop a means to acquire and distribute Logos and include a requirement to facilitate it in multiple Languages. It will demand either a synonym or a unique numeric representation (DigiMet) of each term in law, science, engineering, medicine, strategy, agriculture, engineering, philosophy, poetry, and art in a level treatment in each vocation. Each vocation will add synonyms and DigiMets.

Another aspect is that the software should prompt the author to encourage related topics to become included. The bridge that can cross this divide becomes the tools of Communication that the Logos Communication Platform provides. The Logos File's accuracy may become arbitrarily but not infinitely close to the intended Meaning by digitizing each input.

There must be interaction with the author/editor to capture the terms of a Language into the unambiguous DigiMets of the Universal Language. MetaMath and the Structural Analyzer are tools used to identify which meaning applies to each word. Tools alone cannot always provide a unique answer. For example, consider the input: ‘We must rely on John to make the decision.’ The tools may recognize most word meanings but will not resolve the terms ‘We’ and ‘John.’ For each uncertain symbol, the software will request specific details. After the terms become identified and the definitions stored in the File Header, there will only be confirmation that this is the same ‘We’ upon each subsequent instance. The use of this interactive process allows the Logos File to become unambiguous.

### The Purpose of the Logos Communication Platform:

1) Capture the input's Meaning interactively into an unambiguous metaphor and context.
2) Convert the Meaning into a Logos File.
3) Display the Meaning of a Logos File in any supported Language.
4) Interactively, provide synonyms for word/phrase metaphors, rephrasing, and reformatting the display.

### The Logos Communication Platform Comprises Four Components;

1) Analyze ambiguities of its input and generate queries until it forms an unambiguous metaphor;
2) Capture context sufficiently to indicate the Meaning of the input;
3) Store the Meaning unambiguously as a Logos File in the Universal Language;
4) Display the Meaning in any supported Language, providing access to synonyms and paraphrasing.

### Support for the Logos Communication Platform Comprises Eleven Systems;

1) MetaMath
2) DigiMets
3) Logos File Header
4) Logos File Body
5) Host Language
6) Defining words
7) Universal Language
8) Standard sentence diagrams and templates
9) Structural Analyzer
10) Host Language Definitions
11) Metaphory

### The Processes of the Logos Communication Platform:

A) To create a Logos File:
1) Scan for spelling errors and query each common mistake, such as homonyms (they're/their/there).
2) Fit each sentence to a standard diagram or template; settle the correct DigiMets of words.
3) Resolve each sentence and convert word/phrase metaphors to DigiMets in the Host Language.
4) Resolve sentences that appear to conflict with each other and form paragraphs.
5) Use the Structural Analyzer and MetaMath interactively to make the metaphor unambiguous.
6) Interactively correct errors in meaning until approved by the author.
7) Create a metaphor (File Body) and attach the context and support data in a File Header.
8) MetaMath and the Structural Analyzer reduce the File Body's metaphor to the simplest form and update it into the Universal Language, forming a Logos File Body.
9) Generate an abstract, summary, Table of Contents, or other available options, on-demand using the Structural Analyzer.
10) Complete the Logos File Header, including context, title, and structure, with the author as a search term.
11) Store the Logos File as a Logos File Body plus Logos File Header.
   B) To display a Logos File in any context, Language, and Formality Level:
1) Upon selecting the Logos File, context, Formality Level, and a Language package, the Logos Communication Platform assembles the components and initiates the display sequence.
2) If the Logos File Header is of the selected context, Formality Level, and Language, skip to 8).
3) The Language package and the Structural Analyzer will reconstruct the metaphor into compatible templates in the specified format.
4) The metaphor processes the DigiMets in the Language using grammar rules of the Language package.
5) The restructured metaphor becomes formatted into the Host Language, where it can be read and examined.
6) The author may interact if there is a discrepancy, which will become a correction to the Logos File.
7) The Logos File becomes transferred to word/phrase metaphors and grammar of the Language package.
8) The Logos File becomes displayed in the selected context, Formality Level, and Language.

### The Forward Data Stream;

1) The sender generates a stream of word/phrase metaphors that provide the intended information.
2) The Logos Communication Platform stores the context and versions of all resources in a Logos File Header.
3) Word/phrase metaphors become entered in the Host Language (which may require queries) to form an unambiguous metaphor.
4) The metaphor becomes translated into the Universal Language as DigiMets. Punctuation and structure are provided by the rules of grammar and templates, along with the Logos File Header; this becomes a Logos File.
5) The Logos File provides the information to the receiver(s) using appropriate Language Packages.
6) To compare a Logos File to other Logos Files, they are each accessed in the Universal Language.

### The Elements of Displaying Meaning in a Language;

1) Retrieve the metaphor in the Universal Language from the Logos File Body,
2) Retrieve the context, which may include the time, location, and Formality Level from the Logos File Header,
3) Process the DigiMets, rules of grammar, and punctuation from the Metaphory and Language Package,
4) Assemble the DigiMets, each with its definition, part of speech, gender, plurality, and tense appended,
5) Collect the custom definitions of word/phrase-metaphors into DigiMets from the Logos File Header,
6) Compose the Meaning in the Host Language for approval and correct the Logos File Body.
7) Structure the context and order using templates and MetaMath to comprise the Meaning.
8) Display the sentences, paragraphs, sections, chapters, articles, and manuscripts in the Language.
   The Elements of Corruption-resistance are;
1) Security and passwords required by the Logos Files,
2) Blockchain-protected Language Package and Metaphory.
3) Blockchain-protected MetaMath source code.
4) Blockchain-protected Structural Analyzer source code.

### Enabling Technology for the Logos Communication Platform;

1) Computers able to access terabyte address spaces,
2) Terabyte memories (for Language Package and Metaphory.)
3) Rules of Grammar for each Language (Structural Analyzer.)
4) Host Language,
5) Defining words
6) DigiMets
7) Universal Language,
8) MetaMath
9) Blockchain protection from corruption.

Until recently, there has been no proven method to protect a system's sensitive elements, and it was not sensible to propose this scheme. Blockchain has now proven its ability to resist foreign and domestic hackers. The Logos Communication Platform can now defend its integrity and become built, thereby offering a decisive and realizable improvement to Communications technology.

### Logos File System:

A Logos File Header includes;
1) Context list with its handles,
2) Custom definition list that adds local spellings, as synonyms, to DigiMets;
3) Custom phrases list adds new expressions as DigiMets, phrases, sentence diagrams, templates;
4) Custom sentence diagrams and templates add new structures, equating them to standard ones;
5) Custom block diagrams define blocks and paragraphs as the author selects;
6) Version numbers of the Metaphory and other tracked resources;
   A Logos File Body includes;

DigiMets, sentence structure, and punctuation in the Universal Language,

The File Body is a context-independent metaphor.

To have Meaning requires the Logos File Header, Logos File Body, and a Language package. A Logos Base File is translatable, stable, and combinable. It is the most general class of Logos File. The software of the Logos Communication Platform and a Language package can;
1) Identify and display differences in content between any two Logos Files,
2) Interactively teach a subject Logos Files' Meaning.
3) Display the details of the Logos Files' message, structured according to order and format.
4) Rephrase and paraphrase the message or create a query for more information.
   Logos Base Files include;
1) Contracts, agreements, top management notes, secret information,
2) Financial information and accounting records,
3) Project specifications for Mohoroviĉić discontinuity hole (Mohole),
4) Jonathan William Hertzberg was born on Jul. 13, 1946.
5) Any set of data that qualifies as a Logos File is a type of Logos Base File.
6) Searching several Logos Files together results in a Logos Base File.

### Descriptive Discussion of Logos Communication Platform:

If the original document has incorrect grammar or misspellings, the Meaning is not specific and directly translatable. The Structural Analyzer is an interactive software with access to a supported Language's spellings, rules, and conventions but relies on an editor to make certain decisions. It can convert sentences into proper grammar and order for the supported Language, including indicators to resolve exceptional cases. It will first query to correct spellings. Then it will interact to settle the sentences, which may change some spelling choices. Then, the original input document must be made unambiguous. Many word/phrase metaphors have multiple definitions that still fit in the sentence structure. The software will query each uncertain word and get the exact definition that applies. As it builds the context of the document, there will be fewer queries. Next, it determines whether the current paragraph is of the required format, correct form, and consistent with all details (actual nouns or other).

When there is not a valid trail, an editor must provide the missing information or choose to generalize it. The editor needs only ignore the question to generalize the answer, to wit; ‘John walked into the room.’ The software returns with ‘John's identification: full name ______, John's birth date (B)/age (A) ______; By ignoring the form, John will be ‘John,’ and his file will be empty. If later it is decided that he should be 32 years of age, the file is updated by pressing F1 and then entering ‘John.’ The form will reappear for editing. When John has an unsupported characteristic, it becomes an entry in ‘other.’ A text with no clear meaning relies on the editor.

It is impossible to prove that a document is truthful or says what the author meant to say. Politicians will lie in perfect grammar, and scientists will report precise experiments but make a typographical error. Further processing of the document cannot correct inaccurate input. Therefore, it is necessary to correct the input information.

Correcting an error in the data requires the use of external information. For example, suppose a scientific report has placed grams where there should have been milligrams. Comparing the document against several other references on the same subject will invoke a message: ‘The reported value differs from other studies by a factor of about 1,000.’ Logos processing is limited to the software. The quality of the input determines the quality that is possible in the output. General Language processing depends on first preparing a valid Logos File document. The author must verify that the substance is the correct metaphor as each sentence becomes unambiguous.

A complex sentence can be expressed as multiple simple sentences and allow for selecting order or vice versa. Usually, the process can incorporate some additional words and permit the author to expand on the thought. In this way, an author may be able to deepen areas as desired. The software is an enhancement, not a decider.

An overlay context (such as 200 A.D., city of Rome) may be chosen and then applied by selecting the target text. The formality may be set at will, causing the Language package to offer synonyms in a different order of priority and choosing the synonyms within the Host Language contents at the given formality or level. Once the text is unambiguous, it is translatable into another Language, and the meaning can become finalized. This process will allow a sixth-grade student to access a theoretical physics paper and receive it in understandable sentences.

Once the information is present in the Universal Language, it is available to each supported Language for display with any formality setting. One caveat: as it becomes in the word/phrase metaphors of a Language (other than the Universal Language), ambiguity becomes introduced. The reader who wants to understand more accurately must view more information (synonyms, restatements, paraphrases, and other resources). MetaMath can provide different structures and wordings around a set of definitions that comprise a specific thought either by templates or calculations. It may also be pasted into a new document and then incorporated by providing answers to essential questions. After becoming updated to the same context, one Logos File text may be copied and pasted into a second Logos File and carry all syntax. Any ambiguous or undefined topics will present as queries and be editable. When editing becomes completed, the file becomes a resolute tutor.

The Universal Language information becomes displayed and updated through the Host Language. If a user cannot use that Language, he may request a copy of the Logos File in another Language. After editing it in that Language, the user may translate it to the Host Language and update the Universal Language file.

The Language Barrier that Stymies Communication

In today's Communications, there exists a barrier to accurate expression. It is appropriate to equate these difficulties to the ‘Tower of Babel,’ wherein people of different groups developed Languages that were inaccessible to one another.

Part of the barrier is that people can only vocalize and understand a few dozen phonemes and recognize words with up to about a dozen syllables. The voice-to-ear-to-brain channel can reliably transmit and identify a limited number of phonemes and unique expressions. Long words that differ by only one phoneme or have the order of phonemes switched become awkward to use; no Language uses every combination of phonemes or letters. Instead, Languages use written symbols and spoken sounds plus rules of punctuation and grammar. Each depends on the reuse of constructions with different synonyms to clarify ambiguities.

Suppose every combination of letters becomes defined as a word; we would not have spell checkers as we now know them. Some sequences have become deemed to be too tricky to pronounce; to wit; ‘a apple’, ‘an berry.’

Speed-reading instructors teach students not to sound out terms, thereby removing a layer of the load. The power of speech and symbols has set Homo sapiens apart from other animals; however, our capacity has become limited to a certain number of distinct elements. Each element must typically be the metaphor commonly referred to as a word. These elements should be helpful to form sentences and have listed symbols in dictionaries of various Languages. Many metaphors exist as sentences or books but not valuable as words for everyday Communication due to their size or complexity.

People who can read and write (or type) must associate each symbol with 1) pronunciation of the sound, 2) recognition of the sound, 3) How to spell it, and 4) How to read it. Assume that a few people can pronounce, understand, spell, and read all English word/phrase metaphors; those still have multiple definitions.

A profound context is required to carry a Meaning. In common Languages, it is necessary to include synonyms and redundancy for clarity. Workarounds using redundancy and other schemes are laborious. We can't expect to distinguish among the five million different DigiMets of the Universal Language using combinations of phonemes, even if we could remember the definitions and decipher the sentences.

Therein lays the most significant barrier to accurate expression. Once a statement is written in ordinary Language, it is ambiguous because word/phrase metaphors have multiple definitions. The text must use several synonyms for each keyword. This requirement to paraphrase is an incentive for people to develop a familiarity with their Communication tools. Some develop styles that transport the readers into their context.

The number-structured MetaMath can translate the information between various representational systems and evolve as new systems appear. Thus restating and paraphrasing the selected context entries will remove the differences between medical jargon and a commonly used Language.

For example, consider two people collaborating on different terminals examining two papers on anthropology, one written in English and the other in French. One collaborator only speaks Russian, and the other only speaks Arabic. As each reads in his Language, one enters a query, and it displays to each terminal in the appropriate Language. Responses to the question also occur on each monitor appropriately.

Each person currently must carry a significant load while communicating. People find it necessary to limit the scope of topics they understand and read. There is a need for computers to systematize Communication details for civilization to advance beyond its present level. They need computers to scan many documents and rate them as to content. They need computers to identify the ones that should be answered and suggest possible responses. An American who earns a degree in electrical engineering has little incentive to join the Chinese Association of Genetic Engineers. If each person can operate in a single Language without the excess load of constantly guessing at alternate metaphors, there will be no barrier to interdisciplinary Communication. Computers can allow us to expand and dabble in many areas. The degree we studied may only prepare us for applying our skills in other fields. The Logos Communication Platform can save much effort and facilitate collaborations of all types. When people can freely read interesting discoveries in any area of study, their thought habits will change. The American electrical engineer will submit papers to the Chinese Association of Genetic Engineers in proper form and sequence.

To be supported in many Languages, the author or editor must interact with software that identifies ambiguities and provides a context in time and place, including what discipline (chemistry, philosophy, other) applies to the information. When the author enters, ‘The elderly gentleman was savoring his favorite treat.’ The software will ask for details that are then stored and made available for future references. These will allow the name, gender, and age of the individual, his favorite treat (orange, banana, steak (rare, medium, other), the File Header will then store: ‘person 1 (Jonathan William Hertzberg) was indulging in his favorite treat’ (The properties of person #1 will include male, age 75, preferences, and others.) These are accessed as required for the Language and formality of the reader. For example, set to English, informal, colorful, it might display; ‘The old geezer was guzzling moonshine.’

The leveling of the linguistic barrier will alter the sets of priorities of future individuals. Instead of obsessing on how different persons bounce as they walk, group members will discuss their ideas and become bonded because of their thoughts. To wit: A Millennial from San Francisco can marry a Gen X from Germany on their 2^{nd} anniversary, agree to have a child. He sends a semen sample on dry ice and flies over before the due date. They meet for the first time two days before the birth, and if the child's DNA is a match, they set up a household. The method saves a lot of unnecessary steps and doesn't detract from games and networking. They can even let the computer teach them both French in the instance of a girl or Italian if a boy, in which to communicate until the child is old enough to build a presence on the Internet.

The Host Language is important because it controls the selection of templates when adding context. A grammar-structured metaphor plus a context provides Meaning. Once captured in the Universal Language, it can be displayed in any supported Language using the appropriate Language package. When a metaphor becomes processed into the Universal Language from any supported Language, it can become exactly restored into the original Language. It works both ways. It is reversible! People can freely read interesting discoveries in any place and field of study and then respond to them. The Logos Communication Platform breaks the ‘Tower of Babel’ that has confounded and divided the human race.

### Individual Support Options are Key to Peak Performance

Someone who is an expert in biology, mathematics, physics, chemistry, business, politics, all branches of engineering, and a linguist in all Languages is unlikely. Each person is an individual, whether left-brained or right-brained, ‘visual,’ auditory,′ or ‘sequential,’ and with various recall skills. Our current systems are pretty sophisticated but unable to support succinct and accurate Communication because they are a patchwork of conflicting disciplines. We have done quite well with our present system, and it got us to where we are. To go much further, we must attack the barrier that challenges our efforts. It is time for individuals to tap the resources provided by a level playing field and optimize their toolsets using computer support.

The Logos Communication Platform offers an organized structure to empower each type of person independently. All information is stored in uniform and unambiguous Logos Files but with very compliant means of input and output that accommodate any personal preferences and provides the ability to search, summarize, compare, and combine information. The information becomes applied in ordinary Language. Queries seek to refine the DigiMets and sentences' structures to forms that can become recognized by MetaMath. After the author agrees that the substance is correct, the metaphor becomes translated into the Universal Language according to its grammar rules, making it processable. The rules separate each topic and place the subject at the beginning. These may become displayed in the correct order in any supported Language; the supporting modifiers become provided under each case.

The method of comparing Logos metaphors is by reducing them as follows. All sentences become made into simple sentences, and the subjects become sorted numerically. Each topic's modifiers become sorted numerically. The system will next replace words with synonyms to find matches. Because the metaphors have been made unambiguous and the sentences standardized, the similarities become exposed. The software will report similar and dissimilar parts for review. This form of file comparison becomes directed toward combining information rather than searching for plagiarism.

In various Chinese dialects, the characters each have a single pronunciation across one group (such as Mandarin) but may be said differently in others. Several characters are homonyms and therefore are ambiguous when spoken. Sometimes these are distinguished by adding 1) a rising, 2) a level, or 3) a falling tone, but there are still many different characters for certain pronunciations. Therefore, a way to identify the actual Meaning of the different homonyms is necessary. One method of clarifying the intent is by making additional statements to exclude other possibilities. Using phrases that have a specific significance somewhat mitigates the ambiguity. Tones provide extra phonemes to distinguish many characters and are integral but cannot supply enough unique pronunciations. The Universal Language assigns one number to represent each digitized definition. The Logos Communication Platform helps overcome the barrier by providing interactive and stable options for a clear transfer of Digital metaphors. DigiMets have no written or spoken form except their definitions in the Defining words of the Host Language or their Digital Numbers. The only exception is that the Defining words each have a printed DigiMet symbol and can become displayed in the Host Language.

As human civilization progresses, it will become necessary to have Language definitions that include more words. Like having more pixels in a frame, it allows the descriptions to become more finely resolved. Words like ‘atomic bomb’ or ‘nano-particle’ are two-word phrases with single, non-literal definitions. An unambiguous Language is possible by assigning a symbol (number) to each unique variable (DigiMet); each DigiMet has a unique definition, is a dimension, is independent of all others, and is exact in the algebraic sense. Each Language consists of words, symbols, signs, and sounds, all of which are metaphors.

Each definition is assigned a number for its DigiMet and is associated with a part-of-speech and other parameters. Each time a new entry contains the identical definition as another, it is associated with the original number, and each will become placed its list of synonyms. There will be cases where the defining metaphors' incompleteness may cause two DigiMets to have one definition. The two are then corrected to provide an individual definition for each metaphor. Commonly used phrases such as ‘dead on my feet’ may have the synonyms ‘tired’ or ‘sick’ and have other distinct definitions. These phrases are definitions in the numerical list. When encountered in a text, the software will examine the literal definition of each word. It will then request the editor to choose what to use. The next level of progress for civilization is for each important document to become stored in unambiguous Logos Files, accessible in all Languages, and able to be rephrased and clearly understood.

There must be more parts of speech to accommodate the needs of the Logos Communication Platform. Nouns are an example.
1) N1 is a general member of a kind of life; cow, bull, person, man, chicken, rooster, fish, amoeba.
2) N2 is a specific living individual (even after death); Billy the goat, Jonathan William Hertzberg, Napolian.
3) N3 is a named place; North Pole, Spain, Yellowstone, Hanging Gardens of Babylon.
4) N4 is a non-living thing or part of a living thing; the needle, the birdcage, the litterbox, the suit, his liver.
5) N5 . . .

The reason is that each type of noun becomes used differently to form Logos in sentences and paragraphs. These are used differently across Languages. Separately handling the nouns saves the author's time and also computation.

It is necessary to have basic rules for each component to permit a thought to be expressed and be translated into another Language and then be translated back without error. For example, translation from Russian to Chinese would first translate Russian into the Universal Language, then into Chinese. This process requires that the Russian text is in perfect grammar and has the correct spellings. Otherwise, it will become translated into the Host Language and generate queries (in Russian or Host Language) until it becomes unambiguous before becoming translated into the Universal Language.

Multiple translation continuity is the real test of the ability to accomplish single-valued representations. Cross-translation does not mean that an absolute Meaning is possible. We cannot define any word in the absolute sense. It requires MetaMath, which uses a single symbol for each definition. It cannot rely on the context, structure, and conventions of ambiguous words.

Using DigiMets defined in many linguistic systems, plus a Logos File Header enables translation across multiple Languages. It is necessary to establish the structural details that permit a unique Logos to be expressed, including all applicable conventions. When converting a document in the Universal Language to another Language, using a phrase to form a word's equivalent is possible.

By assigning a single number to each definition (metaphor) and using it as the address for only one DigiMet, it is possible to create one fully defined symbol (the number) for each word/phrase metaphor irrespective of Language. These should become limited to words and phrases; generally, parts of speech found in dictionaries and valuable in communication should not be long discourses. In some Languages, three-word phrases have become commonly used as metaphors. A DigiMet may represent an exact definition that becomes represented by a phrase. That amount of error is the exchange for providing a simple translation. Just as a pixel with a certain number of colors is a digital display of an actual three-dimension image, a DigiMet is a metaphor represented by a number. It can invoke synonyms in any supported Language. The reader may request the synonyms of any word or its definition. If the reader asks the definition of a word in a phrase, the whole phrase will become returned and its DigiMet definition; to wit, ‘be a monkey's uncle’ Def: ‘be very surprised.’

All current accounting, records, travel, Communication, Language, and art forms will be dependent on digital processing. As all forms of engineering are rapidly converting to computer processing, it should follow that all current Languages will streamline toward a single system of unified representation and be available in a standard-Language human interface. Eventually, the verbal Languages will shift. Logos' actual compact presentation will likely become standardized because it will yield uniform processing of Meanings. Words with many definitions will be less preferred except for their most common uses, and the English-speaking reader will have a lesser load when reading Arabic.

Logos will finally become stored in compact files within the Logos Repository, plus details in each Logos File Header plus Language Packages that will be as inaccessible for humans as Sanskrit. In addition, information becomes available through translation-on-demand in any supported Language, and any formality by interaction with the Metaphory and MetaMath resources through the Structural Analyzer.

The human interface resource will include support for voice/digital/scanner/keyboard/data channel input and speech synthesizer/digital/display/hardcopy/data channel output. Current technologies can easily extend support to Braille and Sign Language. The system also becomes a training aid.

The Phonary is an ordered listing of word/phrase metaphors from the Metaphory through a Language package, with pronunciations beginning with a specific phoneme sequence. It can aid an author in searching for a word that is vaguely in mind. It is like searching through a dictionary where words are in alphabetical order.

The Rhymary is an ordered listing of word/phrase metaphors from the Metaphory through a Language package, with pronunciations that end with a specific phoneme sequence. It can be helpful to poets, songwriters, and marketing writers. This assistance becomes achieved by providing access to word groups that are not immediately obvious.

The Punary is an ordered listing of word/phrase metaphors from the Metaphory through the Language package: homonyms of a target word/phrase metaphor. It provides diversity to songwriters and politicians as they strive to find ways to include a variety or avoid the wrong word choice, to wit: their, there, and they're.

Digital meaning-Thesaurus: This is a software routine that extracts word/phrase-metaphors that include exact or similar definitions as a search symbol; it will return all spellings and phrases that are synonyms, and synonyms of each synonym's spelling will become returned; it is only necessary to enter a word symbol to display the return set; hovering over a word symbol from the return set will display all definitions; the DigiMet number will appear upon selecting a symbol and pressing control-C; the search may be made limited to a part of speech, tense, or gender; the user's preference for screen Language remains unless separately changed; the software will remove repetitious word symbols. This software is Language independent and can become set to the Language package of choice. It functions to allow finding alternate ways to express ideas, recall spellings and add diversity.

### How the Logos Communication Platform Resolves Interdisciplinary Confusion

A well-educated man reading a paper on the effects of a decrease in a bio-catalyst on a rare disease's outcome would have few resources (such as reading the abstract or exercising blind trust in a journalist). (Both of which may be misleading as the journalist may have only read the abstract.)

To satisfy himself as to whether the paper's body supports the conclusion, he may find unbridgeable gaps between the vocabulary and conventions of organic chemistry versus his background.

These differences may be insurmountable unless he can request specialized assistance to rephrase some sentences into a common Language until he can comprehend the details. Here a sentence may require several paragraphs of discussion to decipher and elucidate what was in one sentence. Equations that have standard translations are condensed forms that can evaluate verbally or mathematically. He may need to explore both avenues of thought to understand the paper. Once the man can see the information from various perspectives, he will make meaningful judgments and assessments regarding the document.

A user can combine two Logos Files resulting in a seamless document (primarily by software). The processing may use each paper's context, which may date from different times, but each is current at its time context. If a previous software version made the file, some context revision is required to update it correctly. The reader is insulated by the universal ‘Please Wait’ while applicable layers of context are accessed. When the file is ready, the reader may query it to find an improved understanding.

In this manner, Logos is accessible later, as long as the context is updated. Furthermore, the Universal Language is equally usable in any supported Language: English (US/BR), French, German, Swedish, Italian, Arabic, Chinese, Indian (Punjabi, Gujarati).

Another property of each definition is its origin or usage; such a case is ‘port/starboard/bow/stern,’ which becomes preferred in maritime-current context, but not in general U.S. English and must become referenced to the vessel not the observer.

Properties of proper nouns are available from the Logos File Header. Each noun will be described and collected in a single identity file. The software will ask properties such as name, age, and height at the first instantiation of a proper noun. Each subsequent instance verifies whether this is the same noun and may ask for further details if it is not. Each noun will be tagged with a universal identifier so that various files may become combined without confusion. The author shall have the option to answer or generalize each property, which may seem torturous at first glance. However, time and experience will allow an author to navigate quite quickly. Properties of information content such as past/present/future, active/passive voice, and structural systems of order are derived from the appendage to each DigiMet and, in some cases, the context. As a caveat, if the author ignores the offers and types in new text, the system will conform to the input. As the author becomes more experienced with the system, the author is free to ignore these tools, and the software will judge the grammar impartially. This choice may be more efficient than composing interactively.

Using the Metaphory, the software will rephrase and change formality and replace synonyms in that Language (by constantly referencing the Language Package in the target Language): it will be parsed and then examined for ambiguities. As soon as it identifies a fatal error, it will request clarification and repeat the process until the file has been made unambiguous. It will then provide the translation into the Target Language. Translating it into a third Language will parse and then ask for any detail needed to be free of ambiguity in the new Language. This step will diminish as each Language Package becomes mature.

The default settings will request the full name and date of birth for each proper noun (person, racehorse, pet, city, or other) when examining a file. The request (made by presenting a form) is satisfied by answering each question by filling it out, generalizing, or editing the format. Once the data is stable for a proper noun, each instance must verify it is the same.

A file may be unambiguous in the Universal Language; however, there may be ambiguities when displayed in any other Language because the words used may also have additional definitions. Setting the software to display in the ‘verbose form’ will add sentences with other synonyms or display lists of synonyms in brackets or colored font/background. Alternatively, (if set to display in the explicit form), it will show each word's Host Language definition plus punctuation instead of the synonyms.

The author may request a specified definition denoted by a specific phrase or spelling to become stored in the Logos File Header. Additional support for the author comes from the Metaphory that can support a dictionary, thesaurus, Phonary, Rhymary, or Punary in each supported Language. This access helps the author to discover different styles to clarify the Meaning.

Consider, ‘He then lead the lead dog to find a lead pencil and lead weight which provided a new lead.’ It is only necessary to hold the cursor over each uncertain word to expand it into a ‘verbose form’ and find its definition and synonyms in each instance, including pronunciations. Choosing the preferred synonym will direct the system to present that spelling in that location.

Languages spell words out of an alphabet or use characters, sometimes combined into multi-word phrases with commonly understood significance. There are 600,000 words and about 900,000 multi-word phrases in use in the English Language. The reader must grasp the context to know which applies. Many phrases are just idioms used locally and not understood generally. Moreover, each word or phrase may have several definitions. The definition of a word in one Language may match a word in another Language or not.

In the English Language, there are many homonyms. Some of them have different spellings. Those that have common spellings but distinct definitions often appear sequentially in the dictionary. There are also words with identical spelling but different pronunciation or tense, to wit:
1) lead=to draw forward from the front,
2) led=having been previously drawn toward,
3) lead=element #82 in the Periodic Table of the Elements,
4) lead=a clue to solve a mystery,
5) lead=a position in a group ‘the lead dog,’
6) lead=the center of a pencil, made of clay and pigment.

Context has multiple general aspects. Firstly, spellings for definitions applying to a limited range of dates, Languages, and localities, secondly for a science, profession, or religion. In each case, these are add-ons to a Language, but there are no rigorous rules. The same Metaphory applies to all contexts of all Languages. The immediate add-ons are whatever the author wants, and they are only in the header of the current file. Authors may keep a list of add-ons that provide their styles to pre-populate their manuscripts' headers.

A context is applied either as an aid to understanding or by an author writing a document. A context may either add or remove words and add spellings or change the order in which spellings appear among the list of synonyms. The first synonym in the list has the top priority in each selection, subject to rules about repetition, context, and formality, among other things.

The context allows a book written in the distant past to be easily read now or in the future. It also permits the histories to be permanently stored in a form that will be readable in far future times by updating the context without altering the text.

Since all symbols reference the same set of numerical definitions, this is stable storage to accumulate information for our species. The definition of each word is from a minimum vocabulary of defining words. It is possible to treat each of these at a primary level of pictures and sounds. The MetaMath System with a suitable interface is a stand-alone reboot-of-civilization tool. It makes it possible for students and children to learn from a computer to any level of proficiency with minimum guidance.

While it is unlikely ever to archive all Languages' definitions into the Metaphory, it is a fact that persons with a 10,000-word vocabulary can perform well in daily Communication. Similarly, a Metaphory comprising 100,000 DigiMets will function very well for most applications. Adding digitized definitions is very straightforward. The Metaphory contents must be Blockchain protected. The process of adding a local Language package is appropriate and may become incorporated into upgrades whenever appropriate.

When an upgrade occurs, it receives a version number. Logos Files produced by each version will have their number in their Logos File Headers, permitting backward tracing (which is necessary.)

Processing Files into the Universal Language

The Structural Analyzer can process text files when the Metaphory has enough entries to recognize most of the text's words and phrases. It can recognize new words and phrases. With some external assistance, these then become added to the list in the Logos File Header. As algebraic variables, they support translation forward or backward and other MetaMath functions. When they become translated into the words of a Language, they assume the ambiguities of those words. The reader can, therefore, refine the information by an exploration of synonyms using the software. The intent may become determined within the resolution of the original statement.

The Metaphory is created by directly programming from words, definitions, pronunciations, and sound files. As an author adds a new definition or spelling, it becomes incorporated into the Logos File Header. It may later become an update to the Metaphory with approval. The Structural Analyzer assumes control during the processing of new files. Each time the Metaphory is updated, its version number increments, and a record of the definition numbers affected since the previous update becomes appended.

Text documents and files undergo a scan for a title, author, and structure (‘Abstract’ and ‘Conclusion’). It is not necessary to have any of these, but they will be processed if present.

Each file will fit one of four classes. 1) Files that contain fully integrated Logos. 2) Unambiguous files that may lack context (these sentences can each translate into valid metaphors in other Languages.) 3) Unambiguous files with non-standard sentences with correct spelling. 4) Files that have uncertainties (such as misspelled words or poor grammar.)

A Logos Base File stores Logos and is not a copier or storage bin. When a defective file presents, the system will begin asking questions until the file is correct; and is unambiguous, corresponding to the words' actual definitions. Next, they become processed into DigiMets (Metaphory addresses.) Sentences can process into standard grammar using templates or rules. Paragraphs process into groups and use structure to complete a thought-form. When they become fully processed under MetaMath, they may become stored in the Logos Repository.

If the input filter has the setting ‘Logos,’ then as each sentence is verified and the author selects the file type, the system will determine the intended subject, offer suggestions of a file structure, and suggest some connecting sentences and paragraphs. When the file is complete and satisfies a type, it will be considered Logos. As a file is qualified and processed into the Logos Repository of the Logos Base System, it becomes ranked as one of the following;

### 1) Unambiguous,

### 2) Pending Logos,

### 3) Validated Logos.

The difference between 2) and 3) is that the author must provide the necessary information to comply with Logos' requirements, which guarantees it to process (not to be truthful.) The Logos may also receive a grade. The grade may be tentative, personal, published, secret, or whatever the author may choose.

Each definition shall be accessible in any supported Language. For example, in some Languages, a word or synonym may carry a tense (past, present, or other), a gender (male, female, or other), a connotation (positive, negative, neutral), a formality (formal, colloquial, other), or denote status (royalty, other.) Therefore, the DigiMet shall be identified independently and allow the parameters to apply in Languages where the information is required. To wit, ‘The king said NO!’ In Thai, this might translate to: ‘A decree by his majesty, in the royal Language, absolutely forbids any consideration whatsoever.’

The file will then process and assimilate using rules and store the DigiMet to fill the ‘blanks.’ It will first identify the type and then enter the words (calculated based on things in the current text) in each subsequent sentence. It will then replace and store the words in the blanks that were incorrectly calculated (with position detail).

As files process, they become screened for paragraph structure. As a file is being written or edited, the author may choose a type of document. He will be offered sequences of paragraph types by the system. When this option is active, fully structured skeleton paragraphs become presented with only a few blanks (to be entered). This procedure has the advantage that it makes files more quickly and is more compatible with Logos processing. The Logos Files are equivalent to the other Logos Files but structured in an alternate (diagram/template) style. MetaMath can exchange either for the other.

The entries in the Logos File are:
1. The required header information (version, context, custom definitions),
2. The sentence type (template or diagram),
3. The sequence of DigiMets to fill the open sites,
4. The terminator (‘.’, ‘?’, ‘!’, ‘ . . . ’),
5. Sentence-types (simple. complex, passive, two-clause, template),
6. User-defined templates.

A small segment will become compiled in the Logos File Header as it is processed. It will comprise the DigiMet addresses, the number of occurrences of each synonym, each sentence template used, and its instances. In addition, this segment provides statistical information and offers instant file status.

There are a few million definitions across all Languages. These are definitions, represented as words or phrases in all Languages. The number will increase as Languages evolve and new symbols become accepted. For example, MetaMath will allow a book written today to become displayed in readable form in the far future. In any Language, there are several synonyms for many of the DigiMets.

### Adding Files to the Logos Base

An input file must qualify as a Logos File in the Logos Communication Platform before it is functional. The document's context will collect each referenced individual's time, location, jurisdiction, and authority, and other properties if known. Each individual will receive an object identifier and handle to store a complete set of all potential properties. Required properties receive indicators, and the author may choose to ignore any of them or enter others. All context properties have become stored in the Logos File Header. When comparing two files, most contexts, other than dates and identification information, become ignored.

A scan of the document will find any incorrect spellings and ask questions to identify the intended DigiMets. Possible spellings and an option to add to the dictionary or local Metaphory can replace a word or phrase. If the spelling must remain unchanged (as in a verbatim quotation), a further question assigns a DigiMet to it or appends ‘sic’ after the quote. There will be a scan to identify possible phrases. Suspected phrases may become attached to associated definitions with the consent of the author.

When all spellings are correct, the software will examine the sentences and identify a sentence diagram. If the intent is uncertain, the software will propose the wording diagrammed in various ways. For example, the author may choose a sentence structure and possible replacement of some words (such as there/their/they're and similar errors) or additions.

It will then determine the cases where a word in a location has multiple possible DigiMets. Possible options are to use synonyms and definitions. The words' definition becomes substituted literally in some cases. The appearance may seem different, but the metaphor becomes preserved.

Optionally, the author may use the Metaphory to propose words with similar but not identical definitions. They will become found by requesting the synonyms of homonyms. The process is not exact, but it can assist when the author is searching for a word.

As each sentence becomes a set of exact DigiMets, periods, commas, and other punctuation are applied as required. It will ask and add words implied (such as: ‘he decided to proceed,’ which meant ‘he decided to proceed with an investigation’). The Logos File Header will contain enough detail to provide verbose output in all cases. The software will ask for the properties of proper nouns. John Doe is differentiated from John Archer by their surnames, but ‘John Doe’ will be flagged as a possible legal space-holder.

After each sentence is a complete thought, the software will suggest paragraphs, including; creating topic sentences, grouping sentences that apply to the same subject and, adding articles. To structure the text into sections requires the choice of standardized templates. The software can extract the Meaning of a standardized text by using stored templates and the context. The ordered structure is necessary for the completed file to be self-consistent and to become processed as Logos. Order and groupings are critical when multiple files are combined, as they affect the substance. Non-standard word groupings become avoided because they cannot process, but the display is not so constrained. Although the Universal Language file of DigiMets must be rigid, the worded paragraph may display as the author desires. The Logos File Body will be simple sentences. However, the display may have complex sentences and substandard Language that the author specifies as synonyms in the Logos File Header, which carries the details thus required. In this manner, the translations are kept accurate and editable.

Consider that a sentence template is a type that has four blanks and that the first and third will calculate correctly, and the second and fourth blanks remain unresolved. The Structural Analyzer will determine likely words to replace the second and interact with the author. It will then address the fourth blank and its parameters. Finally, when it forms an unambiguous sentence, it will ask the author if the substance is correct, and if so, it will process it into Logos.

Templates come pre-populated with words of the sentence that are fundamental structure (a, the, an, to, and, but, others). Tense is available from word usages and the sentence type. For example, a sentence type in past tense may substitute the word ‘was’ where the sentence type has placed ‘is.’ The Structural Analyzer adjusts the words' forms to become current, allowing synonyms to be substituted as the wording becomes changed. This shortcut uses templates, a condensed form of the MetaMath. The process will become smoother as there are additional standard templates, and the digitization error will decrease.

When many substitutions appear in the Header file, it may mean that the file is an intentional prank or worse. In this case, the file becomes displayed in the Host Language, which ignores the Logos File Header's synonym replacements. The direct translation shows what the file becomes when translated under other Language Packages. If the author chooses to keep a high level of substitutions, the translation will include a warning message.

After the document becomes a correct, unambiguous metaphor, the software will follow the Language and context settings each time it is accessed. These will provide synonyms and placement to make the document better understood and intended for human readers. For example, repetitious use of a single word for a DigiMet defers to using pronouns and phrases if settings permit. The document's completed Logos file can process together with other Logos Files to create a composite Logos File. Conflicts will become questions to an editor and become resolved as they arise.

The software can display the document's Meaning in any supported Language or discipline by reversing the above process using the Language Package for that Language, specialty, or context. When applied to scientific work, recent files will be helpful as updates. The editor cannot always resolve conflicts immediately (given the proper authority.) Some requests are for information that is still unsettled science. He then answers that this is not currently known.

Because the file contains exact DigiMets and the structure is standard, it is possible to compare it to another file and decide whether it provides any new information. The other file will be reordered and restructured in an attempt to find common statement metaphors. The software will search definitions until it finally reports things that are in common between the files. An editor may then pick items to integrate into one of the files and finally erase what is not wanted.

Secret company files will be standard Logos Files that can also accommodate individual access control. Each access may record as well as any changes that the individual makes. Otherwise, they will be encrypted and provided with automatic backup. As further protection, there may be dummy files. The software selectively gives access to the actual files or dummy files, depending on the chosen procedures. The valid password holders will know when dummies are presented (if this option is active.) No error message will pass to the intruder. The financial files are secret and become given all the protections.

As authors provide documents in Logos File form, these will become part of the archive ‘Logos of Man’. A copy of this will be accessible, but the master file will be Blockchain protected.

### Advantages of the Logos Communication Platform

Authors must currently compose documents that systematically provide different synonyms, use well-known phrases, or add useless sentences with synonyms to make the intended Meanings apparent. That method accommodates Language and people's comprehension rate limitations, but it is not very compact and difficult to translate. Moreover, because many words have multiple definitions, it is challenging to phrase an unambiguous statement in any Language.

The use of the Universal Language makes it possible to compose in the same way that the file will be stored and then let the templates form the pleasant and riveting ways of presenting it to the reader. Moreover, this method simplifies the task by using the novel Metaphory and software that allows access to Language Packages.

The Master Repository includes the Metaphory, a list of all available DigiMet numbers, associated definitions, rules, templates, spellings, gender, pronunciation sound files, and implications for the Host Language.

When translating to other than the Host Language, the Structural Analyzer directs the Metaphory to access a specific Language Package containing synonyms, rules, templates, spellings, gender, pronunciation sound files, and implications for that Language. If the selected Language Package does not support a required term, the author must provide it as a local add-on in the Logos File Header. If the author has a colorful phrase that fits the topic, he may replace the standard term in the Logos File Header, and it will affect the display in that Language but not alter the unambiguous file. To wit: ‘Ouch!’ may be replaced by ‘Great balls of fire!’

Logos can also be read from multiple files and combined into a composite file. When there are conflicts among the input file's information, the system can present the competing items and accept a resolution for the composite file (the verified Logos Files are read-only). The combined product can be fully resolved and become a new Logos File. When the file receives verification by the editor, it can do anything that a Logos File can do. Individual Logos Files may disagree with each other, but within a file, the Logos is self-consistent. These can become included in the Logos Repository, the next-to-top level of the Logos of Man.

Logos read from the Integrated Logos Repository is the top level of the Logos of Man. Information in this repository has been verified as self-consistent, has a single Logos File Header, and has been examined and accepted as correct. Once again, ‘accepted as correct’ cannot mean absolute truth. It means accurate within the construct and as a self-consistent metaphor. The system is interactive and can reorder chapters of a report, introducing each topic at its first instance. It can access extension repositories. When the search cannot answer a question, to wit, ‘Is there a road between these two places?’ The simple answer is: Not known! However, the Integrated Logos Repository will support an external search and locate driving and map sites as resources. Extension repositories become automatically included whenever present. When searching for external support, the software reaches out to external sources, not part of the integrated information.

Different fonts, colors, or backgrounds indicate whether the data is from internal or external sources. Of course, Knowledge in its pure form cannot reside in sets of words or DigiMets. Unlike books or videos (with ambiguous definitions), there is no absolute limit to the detail that may go into creating or reading a digital metaphor file. This system of fineness of resolution of the definitions is similar to using pixels to represent an image. Allowing any number of sentences and the substitution of synonyms in any supported Language reduces the ambiguity. Paraphrasing any or all of the details, answering questions, or providing resources provides an approach to convey its stored Meaning to an arbitrary but not infinite degree. It can be a university on a chip(s) when correctly populated.

### The Novel MetaMath

The MetaMath software provides the interface of the Universal Language, Structural Analyzer, and DigiMets to the templates. It applies the rules to interactively parse the text in sentences, paragraphs, and sections using queries and offering templates until the input is unambiguous. As each sentence of text completes, it is translated into the Universal Language and processed by MetaMath into a Logos file. It populates the Logos File Header to provide specifics and store customized choices made by the author. By definition, a sentence provides a complete thought. Each sentence is then translatable into any supported Language. A paragraph is a group of related sentences and may be more efficient to translate into different Languages. Its purpose is to provide structure. Optimizing the file structure, extraction of intent, and many other operations may be done by MetaMath. The result is a smooth connection of the Host Language to the supported Language. New definitions may be made and added to each Language and incorporated into the Metaphory. Each definition is in ‘sixth-grade’ (8,000 metaphors—not words) vocabulary. When the metaphor is expressed unambiguously in the Logos File Body, the Structural Analyzer can determine its Meaning through the Logos File Header's context and the Logos File Body's metaphor MetaMath support.

When an unambiguous metaphor is to be displayed, there is one caveat; the display will be in the words of a Language (other than Universal Language), introducing ambiguity. DigiMets do not have spellings or other symbols (except their number). They may become displayed as their definition in the Host Language. The Defining words' DigiMets do have spellings which are one of their synonyms plus a decimal number. The reader who wants to understand more closely must view more information (synonyms, restatements, and other resources). MetaMath can provide different structures and wordings around a set of definitions that comprise a specific thought either by templates or calculations.

The English Language's human Communication interface consists mainly of sounds, symbols, letters, and numbers. These may be spoken, printed, or displayed on a screen. However, sign Language, ship-to-ship flag messaging, and subliminal advertising are far less significant than spoken, printed, or displayed on a screen.

MetaMath accommodates four of these naturally;
1) Digitized data over a channel or from a keyboard,
2) Printed text scanned and digitized as input.
3) Voice generated by a speech synthesizer from a digitized input.
4) Words that become recognized by voice recognition software and become digitized input.

Communication by sounds is principally through spoken words or text-to-speech. Music, car horns, and sirens, among other systems, carry a part of the load, though in somewhat specialized ways. When we say the word ‘alphabet,’ it is a symbol said by three phonemes. That symbol is no less a digitization than using the letters ‘alphabet’. Digitization is principally standardized for these four types, although sound files, image files, and videos can support Sign Language, Braille, and music. There remains olfactory, tactile, alimentary, electro-stimulation, and art (including any or all of the sensory channels), but when digitized, each may become accommodated by MetaMath.

Humans are distinct from machines in possessing judgment, awareness, and creativity. Applying rules and executing logic including, A.I. (which are forms of mathematics,) are inherently doable by mechanical devices. Language and mathematics may each be poorly defined in some systems and therefore exhibit ambiguity and contradictions. Just as a set of symbols can create a misleading equation, a string of words can tell an untrue story. Language and mathematics are forms of art, may overlap, be combined, or encompass one another.

It is common to consider mathematics as a set of unambiguous definitions and rules that can be extensible in any area of interest with no grey area, but that depends on the definitions and rules. The same fact applies to MetaMath, and the uncertainties are equally resolvable. In Common Algebra; 1+1=2 and X+Y=Y+X. In Boolean Algebra; 1+1=1. In MetaMath; X+Y does not equal Y+X (consider X=is, and Y=it) {is it} is a question, but {it is} is a declaration in English. The rules of grammar, order, paragraphs, and punctuation are operators.

An example of the rules of MetaMath for the Host Language is below.

Jack threw the ball to Mary. Jack gave Mary an orange.=Jack threw the ball and gave an orange to Mary.

Jack gave Mary an orange. Jack threw the ball to Mary.=Jack gave an orange and threw the ball to Mary.

Jack threw the ball to Mary. Jack gave Mary an orange. NOT=Jack gave an orange and threw the ball to Mary.
1) The rules of grammar, groupings, punctuation, and order of occurrence complete a MetaMath metaphor.
2) Two statements that have the same Logos metaphor are equal.
3) Statements in one Language that have the same Logos metaphor as statements in another Language are equal.
4) Replacing a word with a synonym does not change the metaphor of a statement.
5) Replacing a noun by a pronoun does not change the metaphor of a statement.
6) Two sentences that have the same diagram are similar to each other.
7) Two sentences that have the same subject modify each other.
8) Sentences that differ by an adjective are parallel to each other.
9) Sentences that differ by a terminator are perpendicular to each other.
10) Sentences that modify each other and are stacked form a paragraph.
11) When sentences that modify each other are stacked, the first is the topic sentence.
12) Sentences that differ only by helper words are conjugate to each other.
13) A correctly structured paragraph can operate as a sentence.

MetaMath can work freely with a field of a few million single-valued metaphors and rules of grammar. Context is irrelevant to processing metaphors but may become involved in setting up display structures.

Composing with Frame and Storyline:

There are rules for structure, font, and section titles for different document types (such as agreement, marketing page, abstract, book, research paper, press release, disclosure, or other). The sets of rules became converted to templates with provisions to replicate internal blocks. Each of these document types provides a skeleton and a fill-in-the-blanks experience corresponding to the chosen template. As the first part of a document presents, the system will require identity, context, and tense as each applies. Later, it will only identify which items have become referenced.

New typing will append to the paragraph in that location. After entering one or more sentences, the author may choose to select a ‘Function key.’ The text becomes fitted into some number of paragraphs of the types specified. The software will tentatively compute forward from each entry and then allow the author to edit (using a distinctive font or background as it proposes items). As enough substance accumulates to capture the flow, the author may start making sentences. It is also possible to display the sentence diagrams and edit them. The author may choose to see the current document as a block diagram or edit a block at any time. The words proposed by the software (in a distinct color or background) to extend the topic may be corrected or validated when editing a diagram block. The correction will ripple forward appropriately. This method will allow any arbitrary document to receive full support during its drafting. It will automatically form standard sentences and paragraphs that can convert into complex sentences or translate into another Language as a bonus. When sentences become combined, there will be openings to add words to develop the statement further.

At all times, it is possible to select a block and move it to a new position. When repositioning occurs, the software will jump to the beginning and recalculate the document flagging any unverified terms added (after the new location). The editing will then begin at the first unverified word in the revised version.

At any time, it is optional to activate the Structural Analyzer, which will then begin to qualify each sentence correctly and represent each word unambiguously in the Universal Language. Proper nouns will become characterized in the header so that the author may reuse them without confusion. Queries will become generated where necessary. Each word or phrase will be replaced by a DigiMet in the Universal Language version, allowing translation into other Languages. The Host Language version will use the synonyms chosen by the author.

The software will preemptively offer sentence templates that could fit each sentence as an author is composing. Let the Host Language be American English. There is a finite number of sentence diagrams; we can set a ceiling of 1024 (10 bits). Each is standardized (in that it can directly convert to forms in other Languages) or combine to make complex sentences, comma, or colon splices. Each diagram can become set in any tense and populated with several alternative frames. Complex sentences may become converted into multiple simple sentences.

As each present, current words tentatively fill some spaces, and there will be blanks with the possible parts of speech entered and highlighted. As the sentence fits a standard template, it may become accepted. The template provides the required punctuation for its structure. In this way, the first part of a book may be time-consuming for the author, but each selection will offer more complete extensions and reuse specified items as the author proceeds. Typical choices of each type become made from the templates, computed by MetaMath, or developed with interactive prompts that provide suggestions. This process of successive selections will permit a sizeable discourse to be very quickly populated. It is possible to write a paper in multiple Languages simultaneously using these resources. Until MetaMath is mature, the use of templates and interactive prompts is safest. The templates have become pre-computed by MetaMath and tested.

In selecting a section's properties, such as the chapter of a book, the software provides an expected skeleton, the frame for which will typically begin with a topic paragraph according to the dialog in use. Following the Host Language's rules, the software offers a likely paragraph block and sentence template. It then pre-populates the sentence to some extent based on previous wordings. If the skeleton does not seem suitable, hovering over it and pressing F4 will replace it (and may be repeated until one is selected). If the rearrangement changes the first use of an item, the new first use inherits the introductions and appropriately removes subsequent repetitions. This feature requires the author to designate the introductory remarks for each proper noun.

Each blank space will show acceptable parts of speech for the location. Pressing F1 will display the sentence diagram of the template when there is doubt. If the sentence template seems wrong, pressing F3 will switch to a new sentence template, and repeatedly pressing F3 will cycle through many suitable options. As each template appears, it will show the permitted parts of speech for each location and then begin populating them with words. The author may select a space and type a new spelling or hover over it and select one of the suggestions that appear. When an entry does not fit the template, such as the wrong part of speech, the software will look for a template that can accommodate the current wording and offer it. The suggestion may be accepted by a click or rejected by typing into the word. Error correction is active, so typing ‘their’ instead of ‘there’ will be corrected if necessary. The suggested words in blanks are in highlighted or of a distinct font color as preferred. Once a choice becomes made, the other blanks will update for the current sentence. As each sentence is complete, it will change the highlight or font color to the default. The author may delete or add sentences with a selection and a click. A completed sentence may still have ambiguities due to different word definitions. If the software cannot resolve the definitions into a DigiMet template, it will ask questions before the sentence becomes entered into the Universal Language file body.

The Logos File in the Universal Language only requires appropriate words from a Language Package, templates, structure, and punctuation plus context from the Logos File Header to reproduce the identical content in a second Language. Note that a sentence template in the host Language has a corresponding template to translate the metaphor in any supported Language.

When a section is complete, the Structural Analyser will accept a request for optional restatements and paraphrases. It then examines the entire document or a selection and offers new arrangements with identical metaphors. The purpose is to request that the software replace individual words with synonyms or phrases, combine simple sentences into equivalent complex sentences, or other actions. At any time, it is possible to suppress the properties of items, but they will remain in the Logos File Header and be accessible.

Twenty years ago, every manager needed a secretary. As the Internet, word processors, calendars, and tax software became available; secretaries became a liability and a security risk. Ex-secretaries are starting companies.

Today, every author needs a ghostwriter. Grammar-checkers are beginning to erode some of that need at this time. It should become noted that this process is essentially one of removing the authors' burden by the requirements of carefully phrasing every statement. It should become sufficient for them to know what they want to say. Similarly to the secretary, perhaps a good platform becomes the best solution. Free the ghostwriters to become productive individuals. As each creative person becomes free from paying several service people to support their operation, they can raise food in their vertical garden and otherwise become self-sufficient. They will no longer need a specialized software package to do simple communication. The world will change.

### Monetizing the Novel System

The individual functions that would become involved in writing and marketing a book are discrete and are listed below:
1. An author writes a book in some Language.
2. It becomes interactively converted into a metaphor and context in the Host Language.
3. These become interactively translated into the Universal Language as the metaphor plus context in DigiMets and punctuation required.
4. The book becomes translated into any supported Language and chosen formality (this may become specified for each desired version. The output will consist of the actual hardcopy or audio file plus the resource file (DigiMets plus context and punctuation) that may become used to paraphrase the output metaphor.
5. The customer may purchase the format(s) of choice plus a Non-Fungible Token (NFT) to authorize the attached book files to become paraphrased in different formalities and grade levels.
6. Additionally, an NFT (LogosContract) may become purchased to paraphrase any (or all) file(s).
7. Another class of NFT (LogosContract) will permit updating the file(s). For example, these would convert the second edition to the third edition of a textbook or ancient Roman into the current context.
8. The customer then owns the services and restatements (tutoring support) that became bought. If the owner purchased the textbook with updates, it would stay current.
Depending on the market's structure, these functions and LogosContracts may become purchased by an individual, a service provider, or a publisher. Their prices become set as with a book or license. They are attached to the book and move with it, belong to a service provider or the customer. The multilayer structure of the Logos Communication Platform enables this novel use of NFTs. It provides a compatible vehicle for digital, Blockchain, and tutoring functions. It is well-suited to improve commercial development, marketing, distribution, and support cycle efficiency. Scientists who bought a library of textbooks and opened them years later will find them current with the latest edition (the electronic file, not the hardcopy.)

### Example of MetaMath

An author selects an outline of the intended document (1). The next phase describes the document's purpose (2), such as expressing an opinion or teaching how to do something. Then he may enter the topic such as karate or playing the guitar (3).

As a text becomes entered, the Structural Analyzer (4) stores it, watches for indications of a sentence and queries some words' exact definitions (5). Each DigiMet is a dimension. The rules of grammar allow that certain strings of words form sentences. However, many sets of words don't qualify. MetaMath can compute whether or not a sentence passes the grammar test. Beyond acceptable grammar, there is the matter of tone and substance. The author may enter a noun, a verb, an adjective, and MetaMath may find several possible templates and put up one as a suggestion (6).

MetaMath will continually put such a file into standard templates with Host Language and Universal Language equivalents (7), and the document becomes available in all supported Languages. The file becomes translated into the Host Language (8). The use of templates may be displayed or translated into Universal Language (9). The Universal Language of the document is the file body (10). An advantage of papers that use the standard templates is that the Meaning of the final metaphor and context (11) can become summarized and stored in the Logos File Header as an abstract (12).

### Example of Generating a Metaphory:

A Metaphory is an enumerated list where each Digital Number associates a unique DigiMet (13), (17). (21), (25), (29) with a Meaning in Host and Universal Languages. An appendage is a component that may carry parameters and attributes such as plurality, part of speech, and others (14), (18). (22), (26), (30), (34). A DigiMet may be associated with the words and phrases (collectively synonyms) represented in each Language. Every synonym may include a plurality, gender, and implication (15), (19). (23), (27), (31), (35). Each synonym may also include properties (16), (20). (24), (28), (33), (36) such as pronunciation and others. These are then sequentially provided to the output (37) under sequence timing of the Language Bus (38), Language Bus (39), and the Digital Number Bus (40).

Each DigiMet's structure is;
1) Digital Number—24 bits (41),
2) Properties—24 bits (42),
3) Definition—1024 bits (43),
4) Synonyms—6 bits (44),
5) Checksum—4 bits (45).
   Each synonym's structure is;

1) Synonym Number—6 bits (46),
2) Spelling—64 bits (47),
3) Phoneme string—64 bits (48),
4) Sound file address—64 bits (49),
5) Tone, and Implication—64 bits (50),
6) Checksum—4 bits (51).

### Example of Frame and Storyline:

The input is the keyboard (52), and the output appears on display (53). The author selects ‘Open Storyline’ (54). It becomes possible to structure a complete block diagram and then fill the blocks with text in any order. The author is only required to select the goal such as paper, document, or book (55), then select the necessary chapter templates in the order envisioned to prepare a working scratchpad (56). It is possible to write the ending and then the beginning or any desired sequence.

The first paragraph selection presents choices for the ‘Style of Frame.’ These become labeled as ‘Fiction,’ ‘News,’ ‘Technical,’ ‘Promotional,’ or ‘Neutral’ (57).

The subsequent paragraphs present with ‘Continue,’ ‘Introduce,’ ‘Summary,’ ‘Conclusion,’ ‘Custom’ (58).

The author can pick any available paragraph template. A diagram block presents, indicates its type, and the subsequent text becomes its label (59).

Assemble and display the current outline and display the current text of the chosen component. The Frame and Storyline structure acts as a guide to monitor the author to know that he is successfully following the intended outline or to report the current process and avoid overlooking essential points becoming made (60). These processes are all carried out and sequenced by the Control Bus (61).

Each frame's structure is; Digital representation—8 bits, Block pattern—64 bits, Sentence pattern—64 bits (62).

Each Sentence's type is; Digital representation—12 bits, Diagram—64 bits, Template—64 bits, Check—6 bits (63).

Each Sentence's structure is; Digital representation—12 bits, Fixed words—64 bits, Punctuation—64 bits (64).

### Example of Logos-Based Data:

The Logos File Bus (65) presents a verified Logos File which consists of two interwoven parts. The first part is a Logos File Header (66) that includes all of the context information (67) as well as the details of the proper nouns (68). It also provides extensions to the DigiMets (69) and lists specific choices of synonyms that are detailed (70), As well as font properties (71). Version numbers (72) of Metaphory and other sources used (73).

The second is a Logos File Body (74) which includes all of the metaphor as DigiMets (75), the necessary punctuation (76), structural details (77), chapter headings (78), section headings (79), and title (80); a metaphor in the Universal Language and can become displayed, restated, or paraphrased using the words of any supported Language.

The Structural Analyzer (81) can display the information in a Language directly or paraphrase it at different Formality Levels, answer questions and explain complicated statements in sixth-grade definitions or above vocabulary (in the Host Language) using information from the Metaphory (82). In other Languages, it can provide translations of the answers under the direction of the Output Control Bus (83). All outputs become displayed on the Logos Output Display (84).

### Example of the Logos Communication Platform;

The sender provides a statement (78) that provides the intended information. The Logos Communication Platform (79) queries any uncertain content of the message on the query display and stores the context and versions of resources. The CPU becomes represented by an unnumbered image because each step is designated, and all actions are internal to it. Upon receipt, the Logos Communication Platform (80) stores the context and provides the File to the Logos File Bus (81) to the selected receiver (83), forming the Logos File Header 1 and the Logos File Body 1. The Component Bus (82) determines which component is selected. Once the complete statement is local to the receiver (83), (84), (85), or (86), the system will process the DigiMets, into the Host Language. Next, applying the grammar and punctuation rules from the Metaphory and Language Package within the CPU, the statement will be processed into the receiving Language and assemble the DigiMets, each with its definition (87), part of speech (88), gender (89), the plurality (90), and tense (91) appended. Next, it will apply any custom definitions that apply (92).

Following the Host Language's word order, the statement will become fitted into sentences in the receiver's Language that reflect the context from the Logos File Header, using templates and MetaMath to comprise the Meaning. Finally, the Logos Communication Platform will display (93) the sentences, paragraphs, sections, chapters, articles, and manuscripts in the receiver's Language. The words are entered in the Host Language, forming an unambiguous metaphor through queries; this becomes translated into the Universal Language as DigiMets. Punctuation and structure become provided, which then comprise a Logos File.

### Example of the LogosCoin and Non-Fungible (NFT) LogosContract Token

The system defines an asset/currency LogosCoin (94).

There is a fixed total number of LogosCoins which are acquired by:
1) Mining (95);
2) Purchase (96);
3) Contributing to new definitions or DigiMets (subject to the board of directors) (97);
4) Providing articles in the Universal Language (subject to the board of directors) (98);
5) Preparing and integrating documents that preserve Libraries' information by developing context updates (subject to the board of directors) (99).

Each LogosCoin has a unique serial number (100) and can be frozen by the owner if it is lost or stolen. Coins may become traded in fractional amounts, but a fractional LogosCoin may forfeit its serial number. The serial number cannot be traced to a person but can identify a nullified coin and reject its value. When reported stolen, the serial number can determine the wallet that received it upon transfer.

Owners of LogosCoin have the right to use the Logos Communication Platform (101) as a thought processor and general translation tool at a price in (LogosCoins) per action (such as rephrase or translate.) The coins are exchangeable with other coins and may be used as a store of value (102).

LogosContract (103) tokens are (NFT) which are non-asset/currency class and convey to the designee to one or more of the following rights and privileges per individual agreements for an agreed-upon price, the number of occurrences, and/or period (104):
1) Paraphrasing and restating (105);
2) Updating to new editions (106);
3) Replacing lost copies (107);
4) Translating into other Languages (108);
5) Providing all new publications in a specific field at a discount (109);
6) Permitting authors to access existing materials free of plagiarism claims under agreements (110).

Thus, an author may purchase a LogosContract token to support the composition and updating of a manuscript. Likewise, an author who has previously published books can hire someone to convert them to other Languages, and LogosNFT can provide benefits.

I claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A communication platform using an interactive method comprising a computer and a source, which source may be 1) a text file plus an editor or 2) an author, wherein the computer receives at least part of a communication from the source 1) accesses a stored language plus rules and 2) forms a query(s) to determine 1) a definition(s) of each word(s), phrase(s) and 2) a property(s) of a noun(s), the computer interactively 1) offers a template(s) and a context(s) in a host language and 2) accepts a change(s) from the source 3) accepts approval of the current template(s) and context(s) as representing a meaning of the at least part of a communication in the host language from said source, said at least part of said communication in said host language is then further processed, with such additional queries as may be required to support a template(s) in a language(s), into a template(s) in a universal language, which become a logos file body and said context becomes a header entry in a logos file, the logos file thus carries a digital meaning of said at least part of said communication in said universal language.

22. The communication platform of claim 29, wherein an owner of a LogosCoin(s) may restrict the transfer of the LogosCoin(s) from said owner's account subject to limits made available by the communication platform.

23. A communication platform using an interactive method comprising a computer and a list, which is composed of unique definitions of words from all languages, defined in a single host language and named in a universal language.

24. The universal language of claim 23 wherein each of the names of the unique definitions in the list is a unique digital number.

25. A communication platform using an interactive method comprising a computer and a list of definitions wherein each definition is accompanied by its properties and its synonyms as well as the rules of grammar, levels of formality and implications of all supported languages.

26. The list of claim 24 wherein the digital numbers act as algebraic variables and support translation forward or backward and other MetaMath functions.

27. The list of claim 26 wherein when an upgrade to the list occurs, it receives an incremented version number, permitting forward and backward tracing.

28. The stored meaning of claim 30, wherein information becomes available through translation-on-demand in any supported language and any formality by interaction with a Metaphory and a MetaMath resource(s) through a Structural Analyzer.

29. The communication platform of claim 21, wherein owners of a LogosCoin(s) have the right to use a Logos Communication Platform as a thought processor and general translation tool at a price in LogosCoin(s) per action.

30. The communication platform of claim 21, that receives a message from a source and extracts the Digital meaning, providing prompts and queries to the source to complete each subject and verify that the communication is complete and unambiguous logos plus context which it stores or passes to a receiver(s) while restoring it into symbols, punctuation, grammar, and the context in any supported Language(s) providing a means for the receiver(s) to rephrase the wording and review a word's, a phrase's or a metaphor's synonyms to understand the message.

31. The communication platform of claim 30, that can query and record the individual elements of meaning until a message becomes a set of unambiguous sentences, paragraphs, and punctuations that comprise a complete statement.

32. The communication platform of claim 31, wherein a software can interactively transfer the complete statement into a complete statement in a Universal Language.

33. The communication platform of claim 32, wherein a Logos Communication Platform can insert sentences, provide synonyms or make a text become more terse.

34. The communication platform of claim 32 that may become a training aid.

35. The communication platform of claim 32, wherein a book may be interactively translated into the Universal Language as a metaphor plus a context in DigiMets and punctuation.

36. The communication platform of claim 35, wherein the book may be translated into any supported Language and any chosen formality.

37. The communication platform of claim 29, wherein each LogosCoin has a unique serial number.

38. The communication platform of claim 36, wherein a customer may purchase the book(s) plus a Non-Fungible Token to authorize the attached book file(s) to become paraphrased in different formalities and grade levels.

39. The communication platform of claim 29, wherein a LogosContract token(s) which is a Non-Fungible Token and is non-asset class and conveys to a designee(s) one or more of the following rights and privileges, per individual agreements, for an agreed-upon price, the number of occurrences, or period; paraphrasing and restating; updating to new editions; replacing lost copies; translating into other Languages; providing all new publications in a specific field at a discount; permitting authors to access existing materials free of plagiarism claims under agreements.

40. The data communication platform of claim 21, which uses Blockchain verification to avoid corruption.
